(19) United States
(12) Patent Application Publication
(10) Pub. No.: US 2025/0320097 A1
(43) Pub. Date: Oct. 16, 2025

(54) Wear Element

(71) Applicant: Caterpillar Inc., Peoria, IL (US)

(72) Inventors: Andrew James MASSEY, Matlock (GB); Michael Gill PETERSON, Fuquay-Varina, NC (US)

(73) Assignee: Caterpillar Inc., Peoria, IL (US)

(21) Appl. No.: 19/177,195

(22) Filed: Apr. 11, 2025

(30) Foreign Application Priority Data
Apr. 12, 2024 (GB) 2405265.6

(51) Int. Cl. B66F 9/08; B66C 23/70; B66F 9/065; G01D 5/14

(52) U.S. Cl. CPC B66F 9/08; B66C 23/707; B66F 9/0655; G01D 5/14

(57) ABSTRACT

A wear element is for placement between a first element of a telescopic assembly and a second element of a telescopic assembly. The second element is configured to slide relative to the first element. The wear element comprises: a first surface comprising an attachment portion for attachment via an attachment feature to the first element of the telescopic assembly; a second surface parallel to the first surface for abutting the second element of the telescopic assembly; and a magnetic element located between the first surface and the second surface at a location fixed relative to the attachment portion. In use, with the wear element located between the first element and the second element: in an event that the attachment portion is proximate the attachment feature of the telescopic assembly, the magnetic element is proximate a magnetic sensor located in the first element of the telescopic assembly; and in an event that the attachment portion moves away from the attachment feature of the telescopic assembly, the magnetic element moves away from the magnetic sensor.

### FIELD OF THE DISCLOSURE

This disclosure is directed towards a wear element, particularly for a telehandler, a machine or telehandler comprising such a wear element.

### BACKGROUND

Machines, such as telehandlers, commonly comprise one or more replaceable wear elements, such as wear pads, wear strips, and/or wear pucks, for location between two moving parts. Telehandlers, also known as telescopic handlers or rough terrain telescopic forklifts, typically comprise an extendable boom or telescopic cylinder to which a work tool, such as a fork carriage or bucket, can be attached. The extendable boom comprises a main boom section attached to the main body of the telehandler via a hinge and a telescopic boom section mounted in the main boom section. The telescopic boom section is slidable along the main boom section between retracted and extended positions. The telehandler may have further telescopic boom sections mounted within another telescopic boom section.

One or more wear elements are located between the boom sections where they would otherwise contact one another. As the boom sections move during operation, it is possible that the one or more wear elements can become displaced from their location between the boom sections. As a result, the friction between the boom sections may increase, which can reduce the moveability of the boom sections and/or cause damage to the machine.

There is an ongoing need to improve monitoring of the position of the wear elements without direct visual inspection, since the wear element could move or be displaced during operation. A particular need is to reduce servicing costs, which can be relatively high due to the cost of the skilled labour required in the servicing of telehandlers. Furthermore, many telehandlers are rented to operators and thus reduced service or down time would be particularly beneficial.

### SUMMARY OF THE DISCLOSURE

Against this background, there is provided:

A wear element for placement between a first element of a telescopic assembly and a second element of a telescopic assembly, wherein the first element is configured to slide relative to the second element, the wear element comprising:
a first surface comprising an attachment portion for attachment via an attachment feature to the first element of the telescopic assembly;
a second surface parallel to the first surface for abutting the second element of the telescopic assembly; and
a magnetic element located between the first surface and the second surface at a location fixed relative to the attachment portion;
such that, in use with the wear element located between the first element and the second element:
   in an event that the attachment portion is proximate the attachment feature of the telescopic assembly, the magnetic element is proximate a magnetic sensor located in the first element of the telescopic assembly; and
   in an event that the attachment portion moves away from the attachment feature of the telescopic assembly, the magnetic element moves away from the magnetic sensor.

By providing a wear element with a magnetic element in a fixed location relative to an attachment portion, it is possible to use a magnetic sensor in the telescopic assembly to infer movement of the attachment portion from the attachment feature of the telescopic assembly in order to provide an indication that the wear element is detached from its intended location in use. Therefore, the wear element with the magnetic element as above provides improvements in the detectability of the wear element when the wear element is installed on the telescopic assembly. In this way, it is possible not only to provide insight that a wear element is missing altogether, but also to provide insight that the wear element has moved from its intended location which may enable it to be replaced or reattached prior to becoming completely detached.

### BRIEF DESCRIPTION OF THE DRAWINGS

A specific embodiment of the disclosure will now be described, by way of example only, with reference to the accompanying drawings in which:

FIG. 1 shows a wear element according to a first embodiment, wherein the attachment portion is proximate the attachment feature, and the magnetic element is proximate the magnetic sensor.

FIG. 2 shows the wear element according to the first embodiment, wherein the attachment portion has moved away from the attachment feature, and the magnetic element has moved away from the magnetic sensor.

FIG. 3 shows a wear element according to a second embodiment, wherein the attachment portion is proximate the attachment feature, and the magnetic element is proximate the magnetic sensor.

FIG. 4 shows the wear element according to the second embodiment, wherein the attachment portion has moved away from the attachment feature, and the magnetic element has moved away from the magnetic sensor.

FIG. 5 shows a telescopic assembly comprising the wear element of either the first or second embodiments.

### DETAILED DESCRIPTION

According to some embodiments of this disclosure, there is provided a wear element for a telescopic assembly. The wear element includes a magnetic element at a location fixed relative to an attachment portion. In an event the wear element is attached to the telescopic assembly via the attachment portion, the magnetic element is proximate a magnetic sensor of the telescopic assembly. As such, in an event the wear element is displaced, or becomes detached from the telescopic assembly, both the attachment portion and the magnetic element will move with the wear element. The movement of the magnetic element may be detected by the magnetic sensor and used to infer a movement of the attachment portion. In this way, the wear element including the magnetic element according to this disclosure may be used to provide insight that the wear element is missing, or that the wear element has moved away from its intended location. This may enable to wear element to be replaced or reattached prior to becoming completely detached.

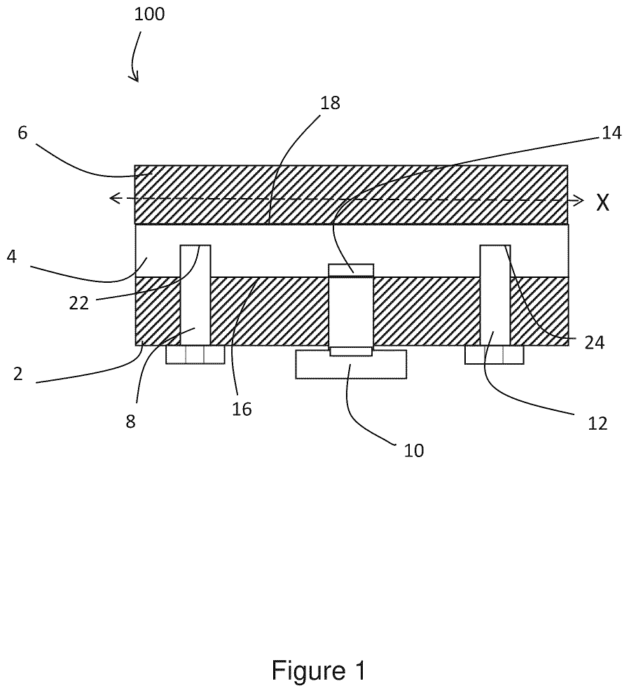

FIG. 1 shows the wear element 4 according to a first embodiment, wherein the attachment portion 22, 24 is proximate an attachment feature 8,12, and the magnetic element 14 is proximate the magnetic sensor 10. The wear element 4 is shown as part of the telescopic assembly 100 comprising a first element 2 of the telescopic assembly 100, and a second 6 element of the telescopic assembly 100. The second element 6 is configured to slide relative to the first element 2. The wear pad 4 may be provided between the first and second elements 2,6 to prevent direct contact between the first and second elements 2,6.

In FIG. 1, the wear pad 4 may be attached to the first element 2. The wear pad comprises a first surface 16 comprising the attachment portion 22,24 for attachment via an attachment feature 8, 12, to the first element 6. For example, the attachment portion 22, 24 may comprise one or more apertures for receipt of a corresponding bolt. The or each of the one or more apertures may comprise an internal thread. In some embodiments, the or each corresponding bolt may screw into the or each aperture to secure the wear element 4 to the first element 2. In some embodiments, for example as shown in FIG. 1, the one or more apertures may comprise a first aperture and a second aperture. By providing at least two apertures for securing the wear element 4 to the first element 2, rotation of the wear element 4 about the or each aperture with respect to the first element 2 may be prevented.

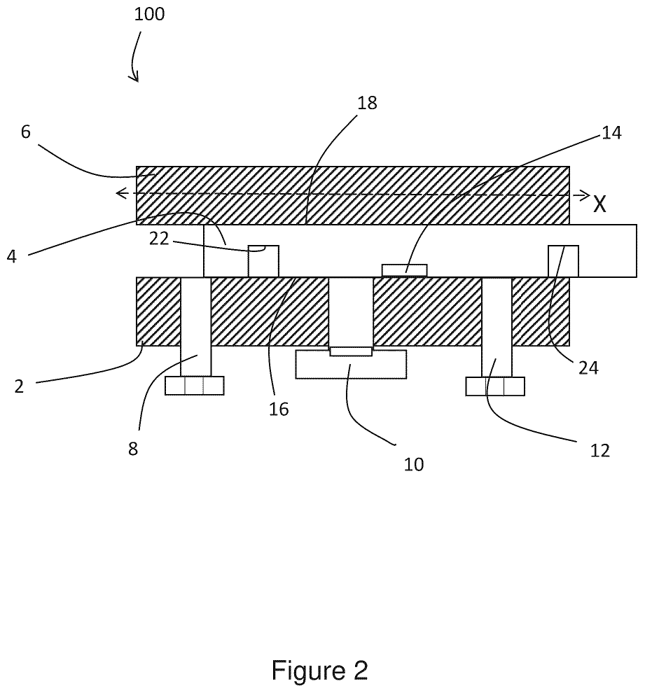

The wear element 4 comprises a second surface 18 parallel to the first surface 16. The second surface 18 is for abutting the second element 6 of the telescopic assembly 100. As such, as the second element 6 slides relative to the first element 2, the second element 6 slides along the second surface 18 of the wear element 4. The second element 6 may slide in either direction indicated by axis X. The sliding along the second surface 18 by the second element 6 may produce friction between the second surface 18 and the second element 6, which in turn may produce a shear force on the wear element 4 in either direction indicated by axis X. In an event the shear force is large enough to break and/or disrupt the attachment between the attachment portion 22, 24, and the attachment feature 8, 12, the shear force may cause the wear element 4 to move in either direction indicated by axis X. FIG. 2 shows the wear element 4 moved in the rightward direction indicated by axis X, for example as a consequence of the shear force.

In FIG. 2, which like FIG. 1 shows the wear element 4 according to the first embodiment, the attachment portion 22,24 has moved away from the attachment feature 8,12, and the magnetic element 14 has moved away from the magnetic sensor 10. As such, in FIG. 2, the wear element 4 may be detached from the first element 2. Compared with FIG. 1, where the attachment feature 8,12 is co-located with the attachment portion 22,24, in FIG. 2, the attachment feature 8,12 has moved away from the attachment portion 22, 24. For example, the or each corresponding bolt may drop down as the connection with the or each aperture is disrupted.

The wear element 4 comprises the magnetic element 14 located between the first surface 16 and the second surface 18. The magnetic element 14 is provided at a location fixed relative to the attachment portion 22,24. Consequently, relative to each other, and relative to the wear element 4, the locations of the magnetic portion 14 and the attachment portion 22,24 are the same in FIGS. 1 and 2. In other words, as the wear element 4 moves, the magnetic element 14 and the attachment portion 22,24 move with the wear element 4.

The telescopic assembly 100 comprises the magnetic sensor 10 located in the first element 2 of the telescopic assembly 100. The magnetic sensor 10 may be configured to determine whether the magnetic element 14 is proximate the magnetic sensor 10 and/or to determine whether the magnetic element 14 has moved away from the magnetic sensor 10. In this way, the magnetic sensor 10 may determine whether the magnetic element 14 is as proximate the magnetic sensor 10 (e.g. as shown in FIG. 1) or has moved away from the magnetic sensor 10 (e.g. as shown in FIG. 2). From the determination, it is possible to infer whether the attachment portion 22,24 is proximate the attachment feature 8,12, or whether the attachment portion 22,24 has moved away from the attachment element 8,12 (e.g. as shown in FIG. 2).

The determination and inference about the magnetic element 14 by the magnetic sensor 10, and the attachment portion 22,24 may be carried out as follows. A controller comprising a memory unit, a processor, and a communication port may be configured to receive a signal from the magnetic sensor 10. The magnetic sensor 10 may determine whether the magnetic element 14 is proximate the magnetic sensor 10. In some embodiments, the determination by the magnetic sensor may be a binary determination of whether the magnetic element 14 is/is not proximate the magnetic sensor 10. Depending on the type of magnetic sensor 10, the magnetic sensor 10 may determine one or more of (i) whether the magnetic element 14 is proximate the magnetic sensor 10, (ii) whether the magnetic element 14 has moved away from the magnetic sensor 10, or (iii) the magnetic element 14 is in motion relative to the magnetic sensor 10. In some embodiments, the magnetic sensor 10 may be configured to determine one or more of (i) to (iii) at a periodic time step, such as every 0.1 s, every Is, every 10 s, and/or the like. In some embodiments, a result of the determination of one or more of (i) to (iii) by the magnetic sensor 10 may outputted by the magnetic sensor 10 and received by the controller. The controller may receive the signal from the magnetic sensor at a periodic time step, such as every 0.1 s, every 1 s, every 10 s, and/or the like.

Depending on the determination of whether the magnetic element 14 is proximate the magnetic sensor 10 by the magnetic sensor 10, the controller may be configured to infer a condition of the attachment portion 22, 24 as follows. In an event that the magnetic sensor 10 has determined that the magnetic element 14 is proximate the magnetic sensor 10, the condition of the attachment portion 22,24 may be inferred as being proximate the attachment feature 8,12 (e.g. as shown in FIG. 1). In an event that the magnetic sensor 10 has determined that the magnetic element 14 has moved away from the magnetic sensor 10, the condition of the attachment portion 22,24 may be inferred as having moved away from the attachment feature 8,12 (e.g. as shown in FIG. 2). In an event that the magnetic sensor 10 has determined that the magnetic element 14 is in motion relative to the magnetic sensor 10, the condition of the attachment portion 22,24 may be inferred as moving relative to the attachment feature 8,12. The controller may configured to infer the condition of the attachment portion 22,24 every 0.1 s, every 1 s, every 10 s, and/or the like.

Based on the condition of the attachment portion 22,24 the controller may be further configured to infer a condition of the wear element 4. In an event that the condition of the attachment portion 22,24 has been inferred as being proximate the attachment feature 8,12, the wear element 4 may be inferred as being attached to the first element 2 and/or in its intended location relative to the telescopic assembly 100. In an event that the condition of the attachment potion 22,24 has been inferred as being moved from the attachment feature 8,12, the wear element 4 may be inferred as being detached from the first element 2, and/or becoming detached from the first element 2, and/or not being in its intended location relative to the telescopic assembly 100. In an event that the condition of the attachment portion 22, 24 has been inferred as moving relative to the attachment feature 8,12, the condition of the wear element 4 may be inferred as moving relative to the first element 2. The controller may be configured to infer the condition of the wear element 4 every 0.1, every 1 s, every 10 s and/or the like.

Based on the condition of the wear element 4, the controller may be further configured to output a recommendation about the wear element 4. In an event that the wear element 4 has been inferred as being attached to the first element 2, and/or in its intended location relative to the telescopic assembly 100, the recommendation about the wear element 4 may be that the wear element 4 is operating as intended. In an event that the wear element 4 has been inferred as being detached from the first element 2, and/or not being in its intended location relative to the first element 2, the recommendation about the wear element may be to replace and/or reattach and/or check the wear element. In an event that the wear element 4 has been inferred as being moving relative to the first element 2, the recommendation may be to replace and/or reattach and/or check the wear element 4. In some embodiments, in the event the recommendation is to replace and/or reattach and/or check the wear element, the recommendation may further comprise a recommendation to stop operating the telescopic assembly 100 until the replacement, reattachment and/or check has been completed. The controller may be configured to output the recommendation about the wear element 4 every 0.1, every 1 s, every 10 s and/or the like.

In some embodiments, the magnetic sensor 10 may comprise a magnetic contact sensor, such as a reed switch. The magnetic contact sensor may comprise a pair of ferromagnetic contacts, which contact each other giving rise to an electrical current in the event the magnetic contact sensor is proximate the magnetic element 14. The ferromagnetic contacts may move to contact each other in the event the magnetic contact sensor is proximate the magnetic element 14 as a consequence of a magnetic field between the magnetic contact sensor and the magnetic element 14. The magnetic element 14 may comprise an electromagnet and/or a permanent magnetic. The magnetic element 14 may be configured to actuate the contacts in the event the magnetic element 14 is proximate the magnetic contact sensor. In some embodiments, the magnetic sensor 10 may comprise an electrical sensor configured to determine a current or a voltage of a circuit of the magnetic sensor. The circuit of the magnetic sensor may be configured to have an induced current in the event that the magnetic element 14 moves proximate to the magnetic sensor 10. In some embodiments, the magnetic sensor 10 may further comprise an output port, such as a wireless connection (e.g. Bluetooth), a wired connection and/or the like configured to output a signal. The signal may be received by the controller.

In some embodiments, the magnetic sensor may have a detection range comprising a distance over which the magnetic sensor can determine one or more of (i) whether the magnetic element 14 is proximate the magnetic sensor 10, (ii) whether the magnetic element 14 has moved away from the magnetic sensor 10, or (iii) the magnetic element 14 is in motion relative to the magnetic sensor 10. In some embodiments, the magnetic sensor 10 may determine (i) based on the magnetic element 14 being with the detection range. In some embodiments, the magnetic sensor 10 may determine (ii) based on the magnetic element 14 not being within the detection range. In some embodiments, the magnetic sensor 10 may determine (iii) based on a movement of the magnetic element 14 within the detection range. In an event that the magnetic element 14 is not within the detection range, the magnetic sensor 10 may be unable to determine any of (i) to (iii).

In some embodiments (e.g. as shown in FIGS. 1 and 2), the magnetic element 14 may be closer to the first surface 16 than to the second surface 18. Whereas the wear pad may move (intentionally or unintentionally) in the direction indicated by the axis X, which affects the proximity of the magnetic sensor 10 and the magnetic element 14, the proximity of the magnetic sensor 10 and the magnetic element 14 in the direction perpendicular to the axis X may depend on the location of the magnetic element within the wear element 4. In some embodiments, such as where a detection range of the magnetic sensor 10 is shorter than the thickness of the wear element 4, in order to position the magnetic element 14 proximate (e.g. within the detection range of) the magnetic sensor 10, it may be necessary to position the magnetic element 14 closer to the first surface 16 than to the second surface 18.

In some embodiments, in the event that the magnetic element 14 is proximate the magnetic sensor 10, a surface of the magnetic element 14 may be proximate a surface of the magnetic sensor. In some embodiments, in the event that the magnetic element 14 is proximate the magnetic sensor 10, the surface of the magnetic element 14 and the surface of the magnetic sensor 10 may be parallel and separated by a distance less than the detection range of the magnetic sensor 10. In some embodiments, in the event that the magnetic element is proximate the magnetic sensor 10, the magnetic element 14 and the magnetic sensor 10 may be in contact along a contact interface defined by a surface of the magnetic element 14 which is parallel to, and in contact with, a surface of the magnetic sensor 10.

In some embodiments, the surfaces of the magnetic sensor 10 and magnetic element 14 may be parallel to the first and second surfaces 16,18. Consequently, in the event that the magnetic element 14 moves away from the magnetic sensor 10, the surfaces of the magnetic sensor 10 and magnetic element 14 may slide past each other. In some embodiments, the magnetic sensor 10 may be configured to determine that the magnetic element 14 is proximate the magnetic sensor 10 based on the surfaces of the magnetic sensor 10 and the magnetic element 14 being overlapping.

In some embodiments, the controller may be configured to infer that the attachment portion 22, 24 has moved away from the attachment feature 8,12 based on the magnetic element 14 moving away from the magnetic sensor 10 by a distance equivalent to a diameter of the one or more apertures. As such, in some embodiments the surfaces of the magnetic sensor 10 and magnetic element 14 may be configured to overlap in the event that the attachment portion 22,24 is proximate the attachment feature 8,12, and to not overlap in the event that the attachment portion 22,24 has moved away from the attachment feature 8,12. In some embodiments, in a plane parallel to the first and second surfaces 16,18, a diameter of the magnetic element 14 is the same as or less than a diameter of each of the one or more apertures and/or a diameter of the magnetic sensor 10 is the same as or less than a diameter of each of the one or more apertures. By sizing the diameters in this way, it may be possible to make sure the magnetic element 14 and magnetic sensor 10 move from overlapping to not overlapping in the event that the magnetic element 14 moves by a distance equivalent to the diameter of each of the one or more apertures.

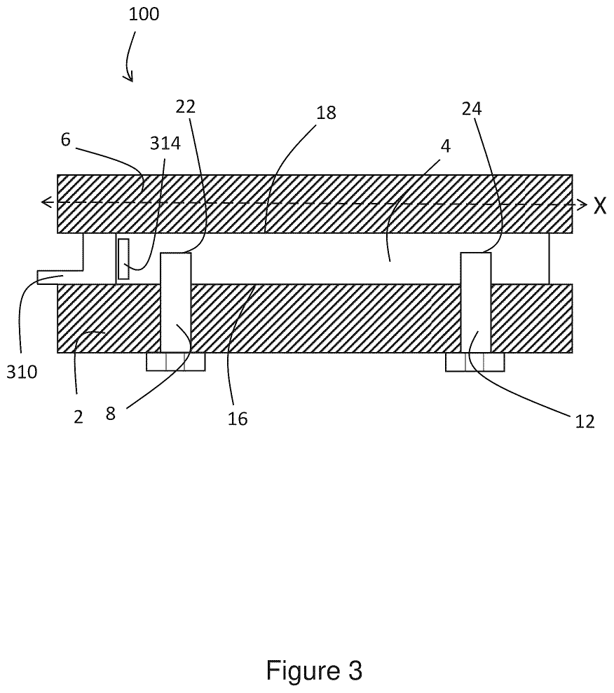

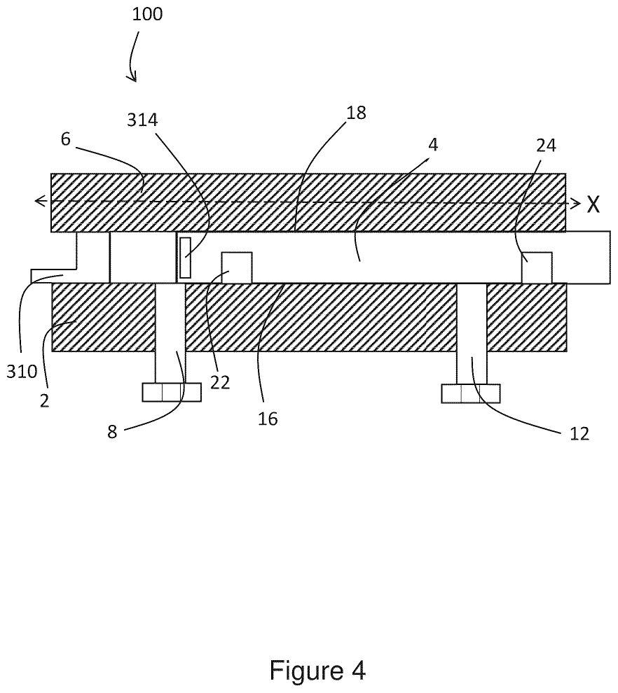

FIG. 3 shows a wear element 4 according to a second embodiment, wherein the attachment portion 22,24 is proximate the attachment feature 8,12, and the magnetic element 314 is proximate the magnetic sensor 310. FIG. 4 shows the wear element 4 according to the second embodiment, wherein the attachment portion 22,24 has moved away from the attachment feature 8,12, and the magnetic element 314 has moved away from the magnetic sensor 310. By comparison with the first embodiment (e.g. as in FIGS. 1 and 2), the magnetic element 314 and magnetic sensor 310 in the second embodiment (e.g. as in FIGS. 3 and 4) is positioned differently with respect to the wear element 4. For example, in the event that the magnetic element 310 moves away from the magnetic sensor 310, for example because of the shear force in the direction of axis X, the surfaces of the magnetic element 314 and the magnetic sensor 310 will move away from each other. By comparison, in the first embodiment, the surfaces of the magnetic element 14 and magnetic sensor 10 may slide past each other in the event that the magnetic element moves away from the magnetic sensor because of the shear force in the direction of axis X. In the second embodiment, as a consequence of the inverse relation between magnetic field and separation distance, by moving the surfaces of the magnetic element 314 and magnetic sensor 310 away from each other, it may be determined over a shorter distance that the magnetic element 314 has moved away from the magnetic sensor 310.

In some embodiments, the wear element 4 may comprise a third surface extending between the first and second surfaces 16,18, and at a first end of the first surface and at a first end of the second surface. In some embodiments, the surfaces of the magnetic sensor 10 and magnetic element 14 may be parallel to the third surface (e.g. as shown in FIGS. 3 and 4). In some embodiments, the third surface may be perpendicular to the first and second surfaces 16,18. The magnetic element 314 may be located adjacent the third surface.

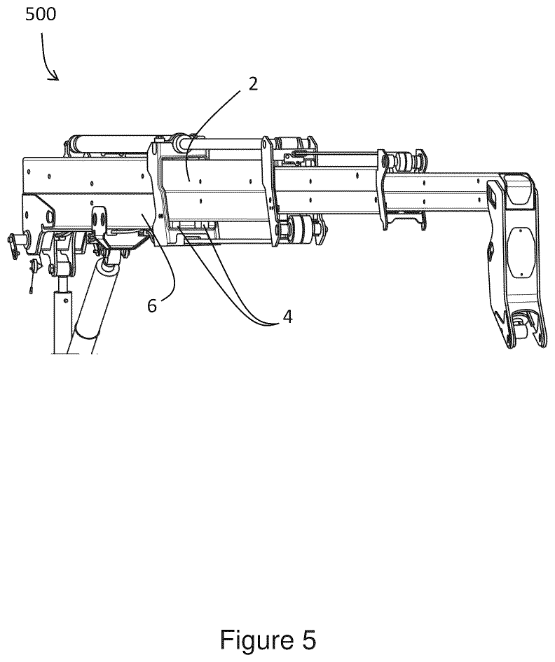

FIG. 5 shows a telescopic assembly 500 comprising the wear element 4 of either the first or second embodiments. The telescopic assembly 500 may be provided with one or more wear elements 4 such that as the first element 2 slides with respect to the second element 4, the or each of the one or more wear elements 4 is attached at the or each first surface to the first element and abuts the second element at the or each second surface. In some embodiments, the controller may be further configured to output the recommendation for each of the one or more wear elements 4, as described above for each wear element. In some embodiments, if the recommendation for any of the one or more wear elements 4 is to replace, and/or reattach, and/or check, the recommendation may further comprise a recommendation to stop operating the telescopic assembly 500 until the replacement, and/or reattachment, and/or check has been completed. In some embodiments, the controller may determine a number of wear elements 4 about which a recommendation to replace and/or reattach and/or check the wear element has been outputted. In some embodiments, a warning may be outputted by the controller if the number exceeds a critical number, wherein the critical number may be one, two, three, or more wear elements.

In any of the embodiments of this disclosure, the wear element 4 may comprise a wear pad, a wear strip, a wear puck and/or the like.

1. A wear element for placement between a first element of a telescopic assembly and a second element of a telescopic assembly, wherein the second element is configured to slide relative to the first element, the wear element comprising:
a first surface comprising an attachment portion for attachment via an attachment feature to the first element of the telescopic assembly;
a second surface parallel to the first surface for abutting the second element of the telescopic assembly; and
a magnetic element located between the first surface and the second surface at a location fixed relative to the attachment portion;
such that, in use with the wear element located between the first element and the second element:
in an event that the attachment portion is proximate the attachment feature of the telescopic assembly, the magnetic element is proximate a magnetic sensor located in the first element of the telescopic assembly; and
in an event that the attachment portion moves away from the attachment feature of the telescopic assembly, the magnetic element moves away from the magnetic sensor.

2. The wear element of claim 1, wherein:
the attachment portion comprises one or more apertures for receipt of a corresponding bolt.

3. The wear element of claim 2 wherein the or each of the one or more apertures comprises an internal thread.

4. The wear element of claim 1, wherein the one or more apertures comprises a first aperture and a second aperture and wherein the magnetic element is equidistant between the first aperture and the second aperture.

5. The wear element of claim 1, wherein:
the magnetic element is located closer to the first surface than to the second surface.

6. The wear element of claim 2, wherein:
in a plane parallel to the first and second surfaces, a diameter of the magnetic element is the same as or less than a diameter of each of the one or more apertures.

7. The wear element of claim 1, wherein:
the wear element comprises a third surface extending between the first and second surfaces at a first end of the first surface and at a first end of the second surface, and the magnetic element is located adjacent the third surface.

8. A telescopic assembly comprising a telescopic arm and a wear element,
the wear element being for placement between a first element of a telescopic assembly and a second element of a telescopic assembly, wherein the second element is configured to slide relative to the first element, the wear element comprising:
a first surface comprising an attachment portion for attachment via an attachment feature to the first element of the telescopic assembly;
a second surface parallel to the first surface for abutting the second element of the telescopic assembly; and
a magnetic element located between the first surface and the second surface at a location fixed relative to the attachment portion;
such that, in use with the wear element located between the first element and the second element:
in an event that the attachment portion is proximate the attachment feature of the telescopic assembly, the magnetic element is proximate a magnetic sensor located in the first element of the telescopic assembly; and
in an event that the attachment portion moves away from the attachment feature of the telescopic assembly, the magnetic element moves away from the magnetic sensor,
wherein the telescopic arm comprises:
the first element and the second element of the telescopic assembly, wherein the first element is configured to slide relative to the second element;
the attachment feature for attachment of the attachment portion of the first surface of the wear element to the first element of the telescopic assembly;
the magnetic sensor located in the first element of the telescopic assembly.

9. The telescopic assembly of claim 8, wherein:
the magnetic element is located closer to the first surface than to the second surface; and
the first element of the telescopic assembly comprises the magnetic sensor such that, in the event that the attachment portion is proximate the attachment feature of the telescopic assembly, the first surface of the wear element is closer to the magnetic sensor than any other surfaces of the wear element.

10. The telescopic assembly of claim 8, wherein:
the wear element comprises a third surface extending between the first and second surfaces at a first end of the first surface and at a first end of the second surface, and the magnetic element is located adjacent the third surface, and
the first element of the telescopic assembly comprises the magnetic sensor such that, in the event that the attachment portion is proximate the attachment feature of the telescopic assembly, the third surface of the wear element is closer to the magnetic sensor than any other surfaces of the wear element.
